(19) United States
(12) Patent Application Publication
(10) Pub. No.: US 2023/0346145 A1
(43) Pub. Date: Nov. 2, 2023

(54) FULLY FUNCTIONAL CUTLERY WITH REDUCED TRANSPORTATION AND SHIPPING FOOTPRINT

(71) Applicant: Hearthmark, LLC, Greer, SC (US)

(72) Inventors: Christopher S. Navratil, Greer, SC (US); Saumitra Bhargava, Clarksville, MD (US)

(21) Appl. No.: 18/310,173

(22) Filed: May 1, 2023

Related U.S. Application Data
(60) Provisional application No. 63/363,826, filed on Apr. 29, 2022.

(51) Int. Cl. A47G 21/02

(52) U.S. Cl. CPC A47G 21/02; A47G 21/04

(57) ABSTRACT

Articles of disposable cutlery are provided herein that include a handle portion, utility portion, and skirt around the perimeter of the handle portion and at least part of the utility portion. The handle portion, skirt, and at least part of the utility portion have a common, uniform thickness without cutouts or ribs, which advantageously enables stacking or nesting of the cutlery, significantly reducing storage space, shipping space, and the carbon footprint associated with storage and shipping.

### CROSS-REFERENCE TO RELATED APPLICATION

This application claims priority to U.S. Provisional Patent Application No. 63/363,826, filed Apr. 29, 2022, which is incorporated herein by reference.

### FIELD OF THE DISCLOSURE

This disclosure relates generally to cutlery and, in particular, relates to uniquely shaped, fully functional cutlery with reduced transportation and shipping footprint.

### BACKGROUND

Disposable cutlery, sometimes referred to as disposable flatware, utensils, tableware, etc., are a high-volume, lost-cost alternative to traditional metal cutlery. Disposable cutlery is often used in situations in which a large number of utensils are needed, such as parties or other gatherings, in situations where cleaning the cutlery is inconvenient or prohibitive, and/or as an accompaniment to fast-food or takeout food orders.

However, disposable cutlery is often manufactured from polystyrene and is typically disposed of in landfills. Plastic waste from food takeout is responsible for more than 20 million tons of plastic pollution, and more than 560 billion individual plastic utensils are used in the United States every year. Furthermore, these cutlery are grouped and packaged in boxes, such as in boxes of 25 or 50, which boxes are themselves grouped for distribution on, for example, skids or pallets. Thus, the emissions associated with manufacturing and distribution of the cutlery is related to the size and weight of the cutlery which affects the size and weight of boxes and pallets.

In order to reduce the amount of waste attributed to disposable polystyrene cutlery, manufacturers seek to minimize the amount of material used in each utensil. However, the utensil must retain sufficient structural integrity to withstand use when a user is eating food, including withstanding the weight of food, cutting with disposable knives, forces attributed to transfer of food to a user's mouth, and the like. Furthermore, the utensil must be able to withstand breakage if a user inadvertently bites the utensil so as to avoid a user ingesting shards of the disposable cutlery.

Reducing material usage in disposable cutlery has typically been achieved by thinning the cross-section of the cutlery and adding cutouts in the cutlery handle. However, these solutions typically come at the cost of cutlery aesthetics and manufacturability/moldability. Offsetting the compromised structural integrity that comes with thinning is typically achieved by creating regimes of increased thickness; the thickness in the neck section of a piece of cutlery is typically twice the thickness of the handle portion of the cutlery, and the skirt on typical cutlery is angled perpendicular to the body with a thickness that is around 1.5 times as thick. However, these regimes of increased thickness experience greater crystallization during molding and therefore shrink both during and after the molding process, forcing manufacturers to hold cutlery in the hold for longer cycle times to avoid shrinking and twisting.

Additionally, reducing disposable polystyrene cutlery waste may be achieved by forming the cutlery from compostable material. However, the effect of material reduction on structural integrity changes with the material used to form the cutlery, so unique challenges exist in achieving reduced material waste, increased compostability, and sufficient structural integrity. For example, selectively thinning portions of compostable cutlery has dramatic effects on the degradation of the cutlery, which may accelerate breakage in use.

Accordingly, improved disposable cutlery are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a comparison of stack height for 24-piece forks, in accordance with the present disclosure.

FIG. 2 is a comparison of stack height for 24-piece knives, in accordance with the present disclosure.

FIG. 3 is a comparison of stack height for 24-piece spoons, in accordance with the present disclosure.

FIG. 4 is a comparison of box size for cutlery, in accordance with the present disclosure.

FIG. 5A is an upper perspective view of a disposable fork, in accordance with the present disclosure.

FIG. 5B is a lower perspective view of a disposable fork, in accordance with the present disclosure.

FIG. 5C is a lower wire-frame view of a disposable fork, in accordance with the present disclosure.

FIG. 5D is a cross-sectional view of the fork in FIG. 5C along the line A-A, in accordance with the present disclosure.

FIG. 5E is a cross-sectional view of the fork in FIG. 5C along the line B-B, in accordance with the present disclosure.

FIG. 5F is a cross-sectional view of the fork in FIG. 5C along the line C-C, in accordance with the present disclosure.

FIG. 5G is a cross-sectional view of the fork in FIG. 5C along the line D-D, in accordance with the present disclosure.

FIG. 6A is an upper perspective view of a disposable spoon, in accordance with the present disclosure.

FIG. 6B is a lower perspective view of a disposable spoon, in accordance with the present disclosure.

FIG. 6C is a lower wire-frame view of a disposable spoon, in accordance with the present disclosure.

FIG. 6D is a cross-sectional view of the spoon in FIG. 6C along the line A-A, in accordance with the present disclosure.

FIG. 6E is a cross-sectional view of the spoon in FIG. 6C along the line B-B, in accordance with the present disclosure.

FIG. 6F is a cross-sectional view of the spoon in FIG. 6C along the line C-C, in accordance with the present disclosure.

FIG. 7A is an upper perspective view of a disposable knife, in accordance with the present disclosure.

FIG. 7B is a lower perspective view of a disposable knife, in accordance with the present disclosure.

FIG. 7C is a lower wire-frame view of a disposable knife, in accordance with the present disclosure.

FIG. 7D is a cross-sectional view of the knife in FIG. 7C along the line A-A, in accordance with the present disclosure.

FIG. 7E is a cross-sectional view of the knife in FIG. 7C along the line B-B, in accordance with the present disclosure.

FIG. 7F is a cross-sectional view of the knife in FIG. 7C along the line C-C, in accordance with the present disclosure.

FIG. 7G is a cross-sectional view of the knife in FIG. 7C along the line D-D, in accordance with the present disclosure.

### DETAILED DESCRIPTION

Disposable cutlery are provided herein including cutlery having a common, uniform thickness across the entire body of the piece of cutlery. It has been unexpectedly discovered that forming the cutlery to have a common, uniform thickness from the handle portion to the utility portion, and including a skirt around the perimeter of the handle portion, the skirt also having the common, uniform thickness, the cutlery has sufficient structural integrity to withstand normal use. Furthermore, by forming the cutlery to have a common, uniform thickness and a shape that complements a second, identical piece of cutlery, the cutlery may be stacked in a way that the stacked height is less than the sum of the heights of each piece of cutlery, advantageously improving the storage and shipping footprint of the cutlery, along with the carbon footprint associated with storing and shipping the cutlery.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

### Articles of Disposable Cutlery

Articles of disposable cutlery are disclosed herein. In some embodiments, the article of disposable cutlery includes a handle portion, a utility portion, and a skirt. As used herein, a “handle portion” refers to the portion of a piece of cutlery designed to be grasped by a user. As used herein, a “utility portion” refers to the portion of a piece of cutlery designed to interact with food, such as the cupping portion of a spoon, the tines portion of a fork, or the blade portion of a knife. As used herein, a “skirt” refers to the portion of the piece of cutlery that “hangs” from the handle portion and/or the utility portion and is responsible for providing structural integrity to the piece of cutlery.

In some embodiments, the handle portion, utility portion, and the skirt have a common, uniform thickness. In other words, the cross-sectional shape of the cutlery is in the shape of a line having a single thickness, the line shaped cross-section having curves or angles as necessary to form the handle portion or the utility portion. In some embodiments, the common, uniform thickness is about 30 mil. Manufacturing variability often introduce small, uncontrollable variability in the thickness across an article of disposable cutlery. Therefore, as used herein, a “uniform” thickness refers to a thickness with less than about 15% variability, i.e., a thickness between about 85% to about 115% of a target thickness.

In some embodiments, the handle portion has a continuous, uninterrupted surface. In other words, the handle portion does not have cutouts, characterized by “holes” or portions where material has been removed such as to reduce the weight or material usage of the article of cutlery, and does not have ribs, characterized by regimes of increased thickness such as to reinforce the structural integrity of the article of cutlery.

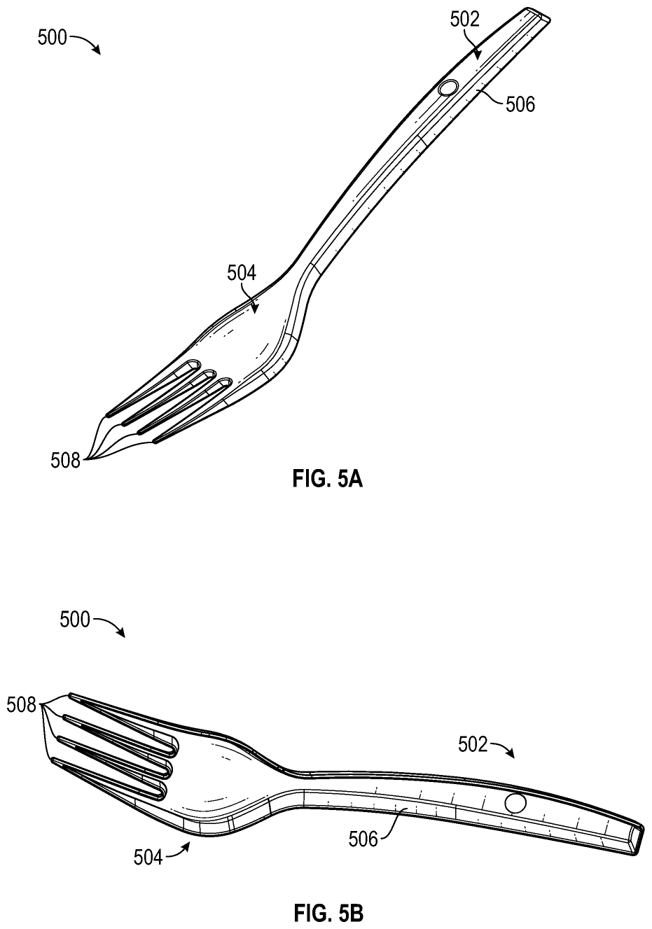

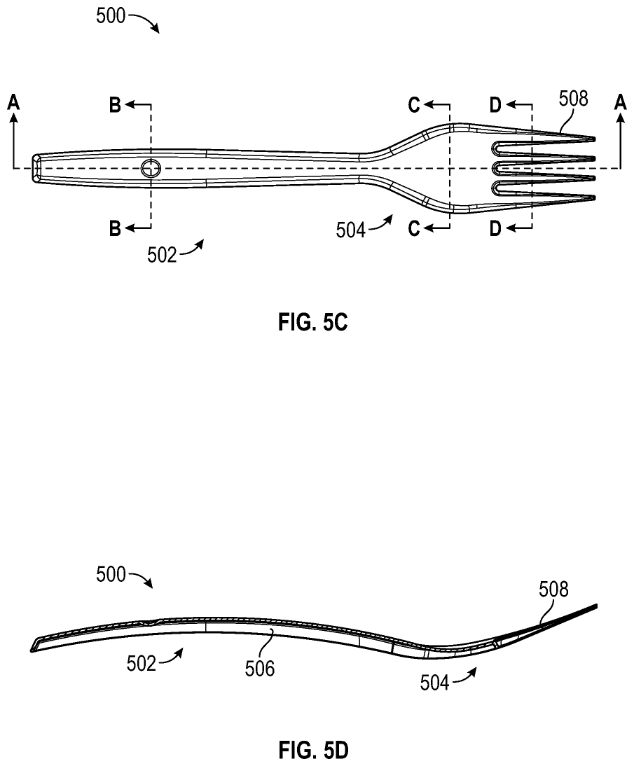

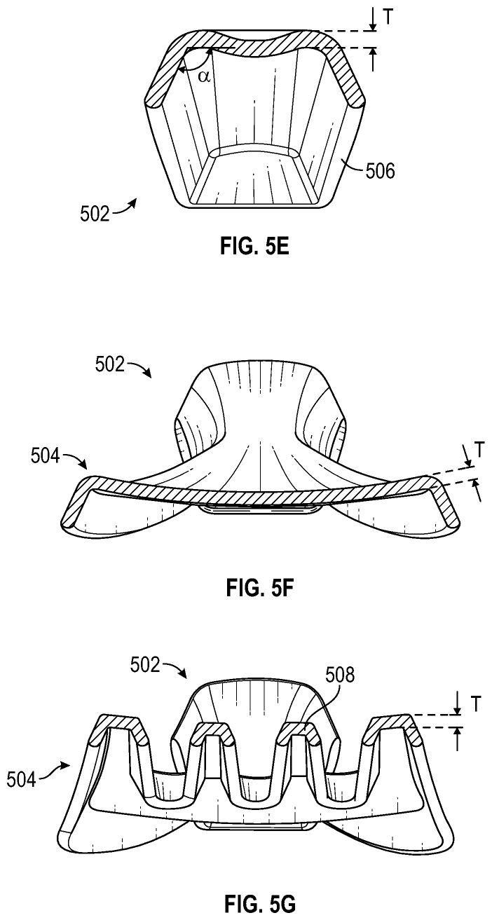

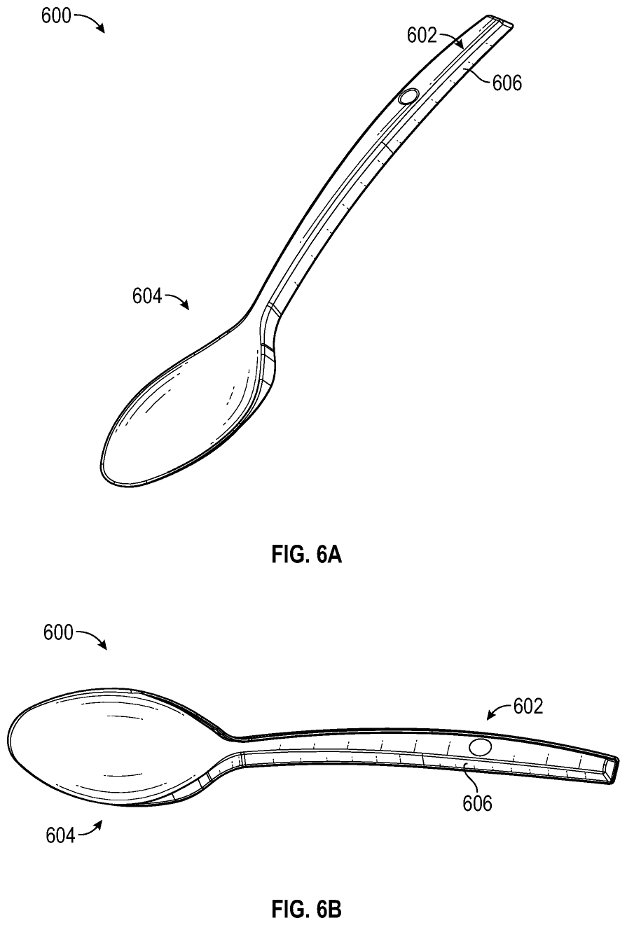

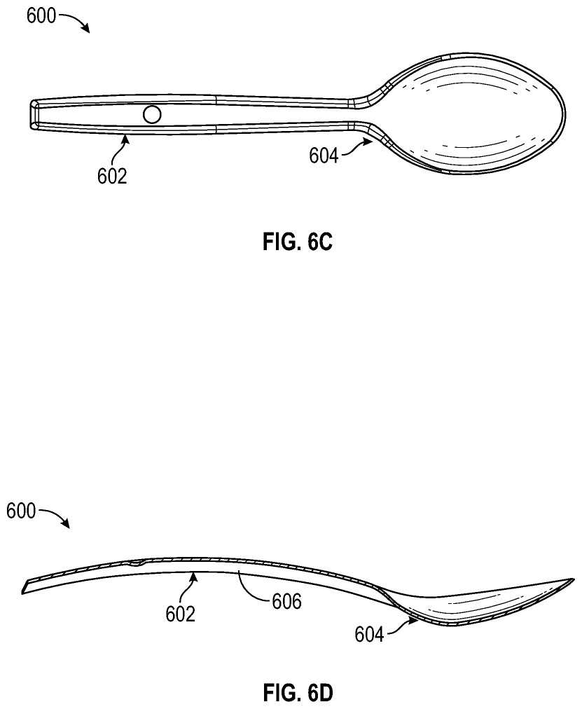

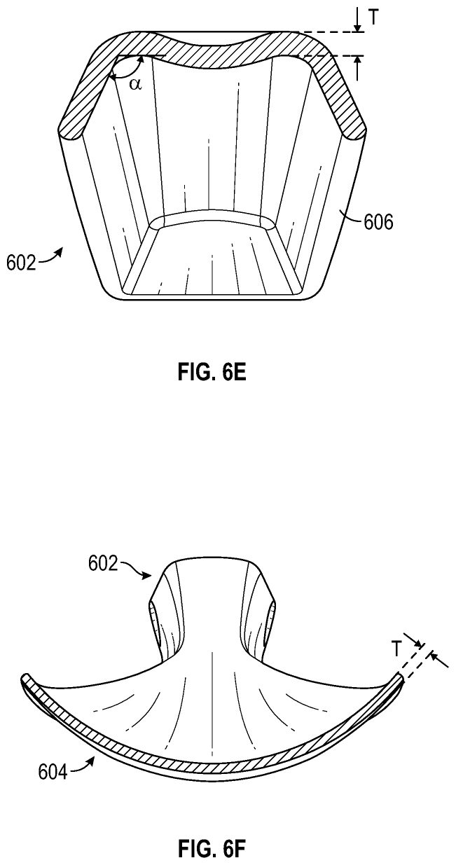

In some embodiments, the skirt extends from the handle portion and/or the utility portion by way of a single angle, such as the skirt depicted in FIGS. 5E and 6E. In other words, the cross-sectional shape of the piece of cutlery may have three distinct sides and two angles, corresponding to the skirt on a first side, the handle portion or utility portion, and the skirt on a second side. In some embodiments, the skirt forms an angle relative to the handle portion and at least part of the utility portion of greater than 90 degrees to about 135 degrees.

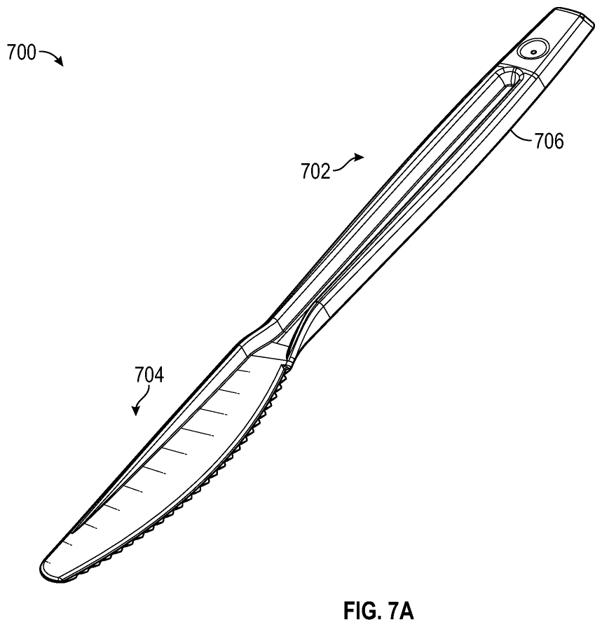

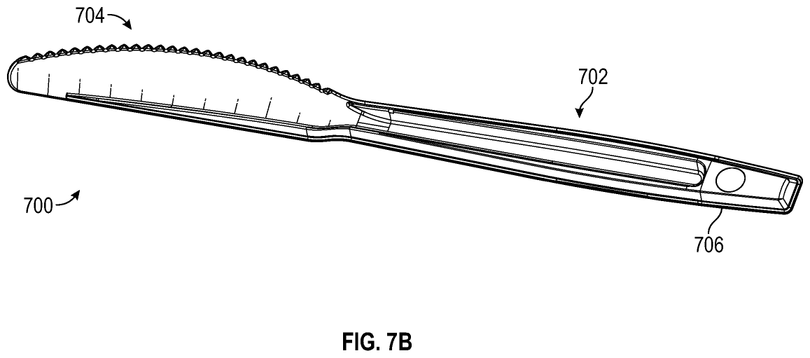

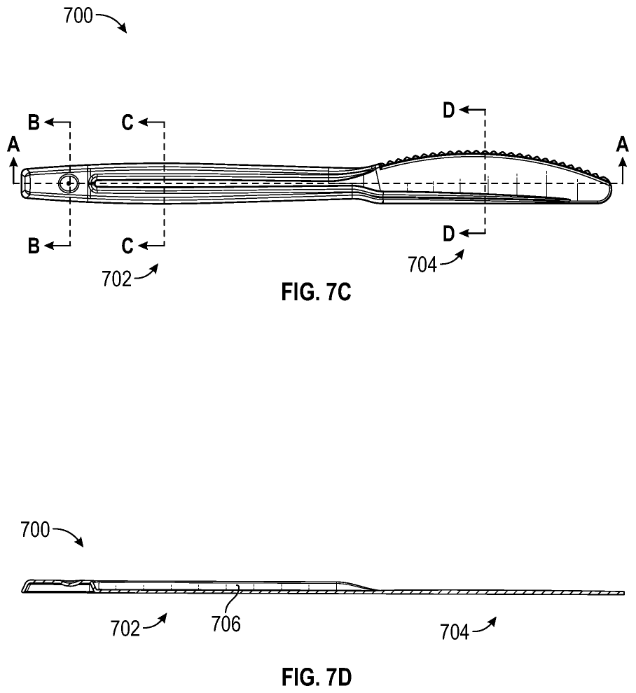

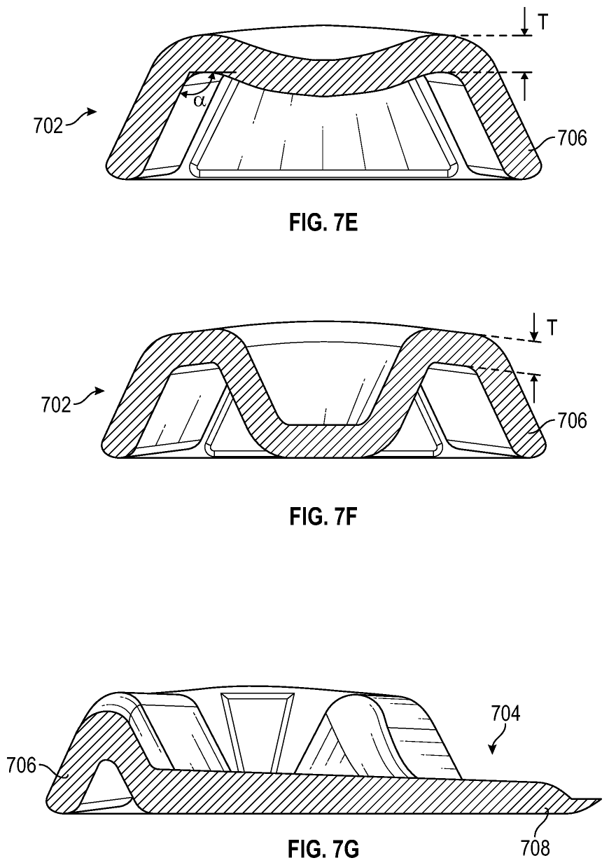

In some embodiments, the skirt extends from the handle portion and/or the utility portion by way of two or more angles, such as the skirt depicted in FIG. 7F. In other words, the cross-sectional shape of the piece of cutlery may have five distinct sides and four angles, corresponding to a “V” shaped skirt on a first side of the handle portion or utility portion, and a “V” shaped skirt on a second side. The cross-sectional shape of the piece of cutlery may have seven distinct sides and 6 angles, corresponding to a “U” shaped skirt on a first side of the handle portion or utility portion, and a “U” shaped skirt on a second side. In some embodiments, the first side of the handle portion and/or utility portion has skirt having a first shape, such as a “V” shaped skirt, and the second side of the handle portion and/or utility portion has a skirt having a second shape, such as a “U” shape. Any combination of sides and angles may form the skirt according to the desired aesthetics provided the “stacking” or “nesting” capabilities of the article of cutlery described herein are achieved.

In some embodiments, the handle portion has exactly one line of symmetry about a longitudinal axis. In other words, the article of cutlery has a longitudinal axis extending from a first end of the article of cutlery (i.e., at the end of the handle portion that is distal to the utility portion) to a second end of the article of cutlery (i.e., at the end of the utility portion that is distal to the handle portion). The article of cutlery may have one line of symmetry along the longitudinal axis such that a “left” and “right” portion of the article of cutlery are mirrored. However, in embodiments in which the article of cutlery has exactly one line of symmetry, the “top” and “bottom” portions of the article of cutlery may not be symmetrical. In other embodiments, the handle portion may have no lines of symmetry, but may instead have rotational symmetry of order two about the longitudinal axis, e.g., the skirt on a “left” side of the handle portion may have a “V” shape but the skirt on the “right” side of the handle portion may have a “A” shape. In other words, the cross-sectional shape of the handle portion is the same after rotating 180°.

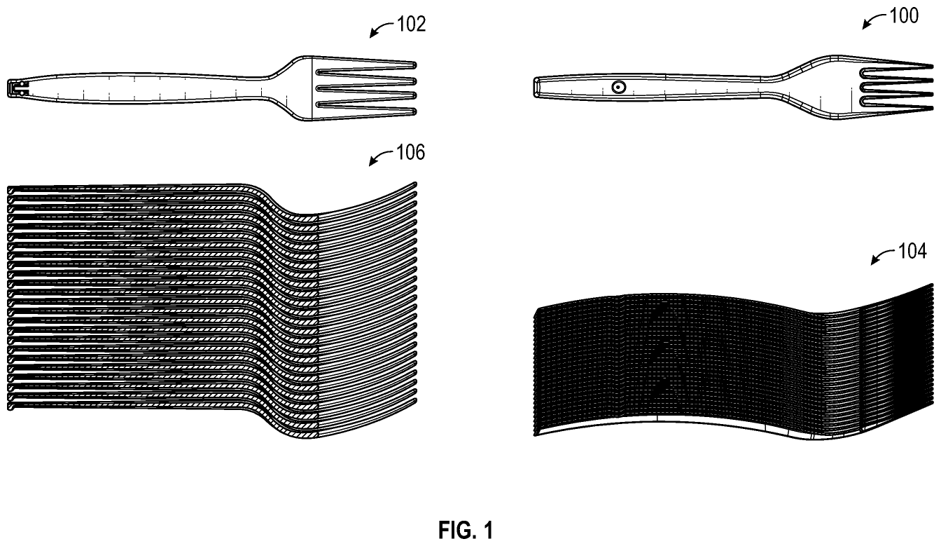

In some embodiments, as illustrated in FIGS. 1-3, the article of disposable cutlery has a shape that is configured to interlock with a second article of cutlery having the same shape. In other words, the surface profile of the “top” of the article of disposable cutlery may mirror the surface profile of the “bottom” of the article of disposable cutlery so that two articles of disposable cutlery having the same shape are configured to stack, nest, or interlock together. In this way, the height of a stack of articles of disposable cutlery is less than the sum of the heights of each individual article of disposable cutlery in the stack. A first article of disposable cutlery may have a first height, a second article of disposable cutlery may have a second height that is equal to the first height, and when the first and second articles of disposable cutlery are stacked, the height of the stack is less than the sum of the first height and the second height. This advantageously enables significant reductions in storage space and shipping space, along with corresponding reductions in carbon emissions associated with storing and shipping.

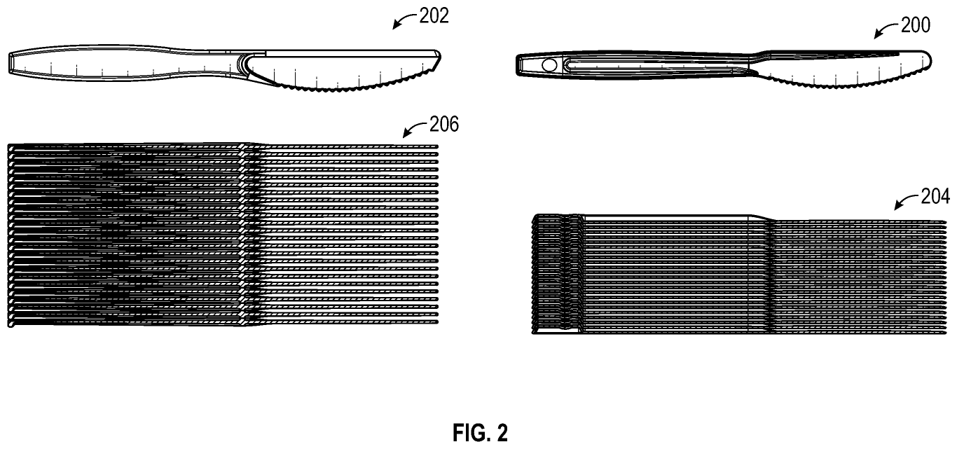

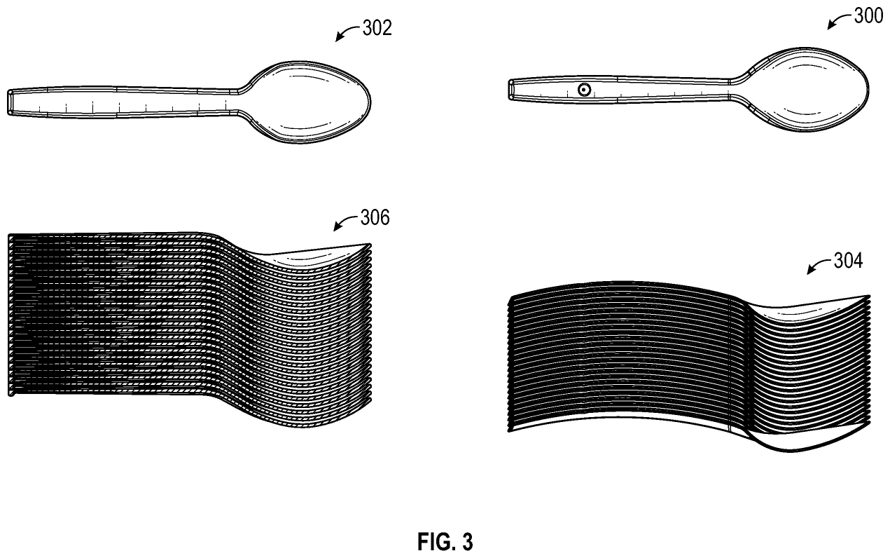

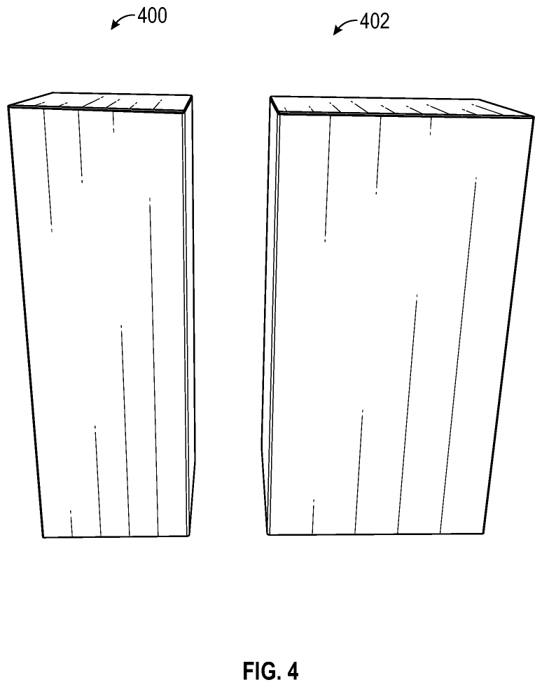

FIG. 1, for example, depicts a disposable fork 100 as described herein and a disposable “heavy duty” fork 102 in the prior art. When a stack 104 of 24 forks 100 is formed, the ability for the forks to stack, nest, or interlock enables a dramatically smaller stack of forks than a stack 106 of 24 prior art forks 102. FIG. 2, for example, depicts a disposable knife 200 as described herein and a disposable “heavy duty” knife 202 in the prior art. When a stack 204 of 24 knives 200 is formed, the ability for the knives to stack, nest, or interlock enables a dramatically smaller stack of knives than a stack 206 of 24 prior art knives 202. FIG. 3, for example, depicts a disposable spoon 300 as described herein and a disposable “heavy duty” spoon 302 in the prior art. When a stack 304 of 24 spoons 300 is formed, the ability for the spoons to stack, nest, or interlock enables a dramatically smaller stack of spoons than a stack 306 of 24 prior art spoons 302. In some embodiments, the stack of disposable cutlery as described herein is between about 25% to about 50% smaller than a stack of conventional disposable cutlery of the same type and quantity. FIG. 4, for example, depicts an exemplary box 400 configured to store a number of pieces of disposable cutlery. Box 402 is a comparative box configured to store the same number of pieces of disposable cutlery. Box 400 may be anywhere from 25% to 50% smaller than box 402 due to the ability for the cutlery as described herein to stack or nest.

The carbon footprint associated with boxes of disposable cutlery, the external bulk packaging containing boxes of disposable cutlery, wrapping skids or pallets loaded with boxes of disposable cutlery, skid storage, transportation of boxes or skids within a warehouse, transportation of skids to a distribution center, storage of skids at a distribution center, transportation of skids or boxes from a distribution center to a store, storage of the skid or boxes at a store, and storage of the boxes of disposable cutlery on shelves in stores accounts for 30-50% of the overall carbon footprint of the box of disposable cutlery. Thus, forming the disposable cutlery as described herein so as to reduce the space necessary to store and ship the cutlery can significantly reduce the carbon emissions associated with storing and shipping disposable cutlery.

In some embodiments, the article of disposable cutlery is a fork, a spoon, or a knife. FIGS. 5A-5G depict an exemplary fork 500 having a handle portion 502, utility portion 504, and skirt 506. Utility portion 504 includes a plurality of tines 508. As depicted in each of the cross-sections in FIGS. 5D-5G, the fork 500 has a common, uniform thickness (T) throughout each of the handle portion 502, the utility portion 504 (including tines 508), and the skirt 506. Furthermore, as notated in FIG. 5E, the skirt has an angle relative to the handle portion of a which is greater than 90° and up to about 135°. In the embodiment depicted in FIGS. 5A-5G, a is about 116°.

FIGS. 6A-6F depict an exemplary spoon 600 having a handle portion 602, utility portion 604, and skirt 606. Utility portion 606 is in the form of a cupping portion characteristic to spoons. As depicted in each of the cross-sections in FIGS. 6D-6F, the spoon 600 has a common, uniform thickness (T) throughout each of the handle portion 602, the utility portion 604, and the skirt 606. Furthermore, as notated in FIG. 6E, the skirt has an angle relative to the handle portion of a which is greater than 90° and up to about 135°. In the embodiment depicted in FIGS. 6A-6F, a is about 116°.

FIGS. 7A-7G depict an exemplary knife 700 having a handle portion 702, utility portion 704, and skirt 706. Utility portion 706 is in the form of a blade characteristic to knives. As depicted in each of the cross-sections in FIGS. 7D-7G, the knife 700 has a common, uniform thickness (T) throughout the handle portion 702 and the portion of the skirt 702 flanking the handle portion, and at least part of the utility portion 704 and the skirt 702 flanking the utility portion. In order to ensure the knife 700 retains the ability cut food, the thickness of the utility portion varies slightly and reduces from the common, uniform thickness (T) that is present in the handle portion to a smaller thickness before tapering to a cutting edge 708. Furthermore, as depicted in FIG. 7E and 7F, the knife 700 has two different cross-sectional shapes in the handle portion 702, corresponding to two different shapes for the skirt 706. Furthermore, as notated in FIG. 7E, the skirt has an angle relative to the handle portion of a which is greater than 90° and up to about 135°. In the embodiment depicted in FIG. 7A-7G, a is about 116°.

In some embodiments, the article of disposable cutlery is formed from one or more of polystyrene, polypropylene, polyhydroxyalkanoate, cellulose acetate, and polylactic acid. In some embodiments, the article of disposable cutlery is compostable. It has been unexpectedly discovered that forming the article of disposable cutlery as described herein to have a uniform thickness through the handle portion, skirt, and at least part of the utility portion advantageously improves compostability by ensuring every part of the article of disposable cutlery is equally susceptible to microbial degradation. Furthermore, by forming the article of disposable cutlery to lack cutouts or ribs, the article of cutlery can more swiftly pass compost studies that measure compostability at the point that less than 10% of the test material is retained on a sieve with 2 mm openings.

Although the mechanical properties and critical thickness necessary to form a usable article of disposable cutlery may vary for each material, the benefits described herein of less storage space, less shipping space, and less carbon emissions are realized regardless of the material.

In another aspect, articles of disposable cutlery are provided herein that include a handle portion, a utility portion, and a skirt. In some embodiments, the handle portion and at least part of the utility portion have a common, uniform thickness, and the skirt has a skirt thickness that is around 70% that of the common, uniform thickness. It has been unexpectedly discovered that reducing the thickness of the skirt can advantageously improve compostability of the article of disposable cutlery without appreciably impacting the structural integrity. For example, an article of disposable cutlery in which the skirt thickness is 70% that of the common, uniform thickness may pass ASTM D6400 30% faster than when the skirt is the same thickness as the common, uniform thickness.

### Methods of Molding Disposable Cutlery

In another aspect, methods of producing articles of disposable cutlery are provided herein including molding the article of disposable cutlery. Conventional molding processes may be used to form the articles of disposable cutlery described herein. It has been unexpectedly discovered that forming the article of disposable cutlery to have a common, uniform thickness as described herein advantageously reduces molding cycle times by 20% to 35% compared to molding conventional disposable cutlery.

### EXAMPLES

### Comparison of Physical Footprint for Pieces of Cutlery

Disposable knives, forks, and spoons were manufactured as described herein. Stacks of 24 pieces were formed and the height of these stacks measured and compared against conventional heavy-duty disposable cutlery. The results are displayed in Table 1.

TABLE 1
Stack Height Comparison for 24-Piece Stacks

| | | | Reduction |
|---|---|---|---|
| Cutlery | Conventional Heavy-Duty | Invented Design Stack | in stack |
| Type | Stack Height (inches) | Height (inches) | height |
| Fork | 3.86 | 2.18 | 44% |
| Knife | 2.99 | 1.85 | 38% |
| Spoon | 3.10 | 2.09 | 33% |

As shown in Table 1, stacks of the inventive design were significantly smaller in height. This experiment was subsequently scaled up to 48-Piece Combination cartons and 48-Piece Fork cartons. The box size necessary to accommodate 48 pieces of conventional heavy duty cutlery was compared to the box size necessary to accommodate 48 pieces of the inventive cutlery. The corresponding number of cases on a skid, the weight of the product on the ski, and the number of boxes on a typical 52-foot truck (assuming 60 skids per truck) were also compared. The results are displayed in Table 2 for the 48-Piece combination cartons and in Table 3 for the 48-Piece fork cartons.

TABLE 2
Comparison of Box Size and Economies of
Scale for 48-Piece Combination Cartons

| | | | Weight | Number of |
|---|---|---|---|---|
| | | Number of | of product | boxes |
| | Box size for 48-count | cases on a | on a | on 52′ |
| Cutlery Type | combination cutlery | skid | skid (lbs) | truck |
| Traditional | 6.875″ × 3.625″ × | 84 | 394 | 60,480 |
| Heavy Duty | 2.875″ | | | |
| Invented | 6.875″ × 2.375″ × | 144 | 438 | 103,680 |
| Design | 2.375″ | | | |

TABLE 3
Comparison of Box Size and Economies
of Scale for 48-Piece Fork Cartons

| | | | Weight | Number of |
|---|---|---|---|---|
| | | Number of | of product | boxes |
| | Box size for 48-count | cases on a | on a | on 52′ |
| Cutlery Type | forks | skid | skid (lbs) | truck |
| Traditional | 6.25″ × 3.625″ × | 84 | 394 | 60,480 |
| Heavy Duty | 2.875″ | | | |
| Invented | 6.25″ × 2.875″ × | 108 | 380 | 77,760 |
| Design | 2.625″ | | | |

As depicted in Table 2, 48-piece combination cutlery formed in the shape described herein require a smaller box, which translates to a 71% increase in the number of cases that may be placed on a skid and a 71% increase in the number of boxes on a typical 52′ truck. Despite this dramatic increase in the number of cases, the weight on the skid is only 11% greater, again due to the improved shape of the cutlery. Although the carbon footprint associated with shipping the invented design is expected to increase by about 11% per truck due to the increased weight, the number of trucks needed to ship a given number of cutlery boxes is reduced by nearly half.

Table 3 demonstrates that for 48-Piece fork cartons, 29% more cases can be placed on a skid, but the weight actually decreases by 4%. Thus, not only are fewer trucks needed to ship a given number of cutlery boxes, each truck is responsible for less carbon emissions.

### Example 3: Comparison of Cutlery Material Weight

Various cutlery was formed as described herein. Spoons, forks, and knives were formed from polystyrene (PS), polypropylene (PP), cellulose acetate (CA), and polylactic acid (PLA) and compared to conventional heavy duty (HD) cutlery formed from the same materials. The results are displayed in Table 4.

TABLE 4
Weight Comparison of Cutlery Materials

| Cutlery Type | Heavy Duty PS (g) | Inventive PS (g) |
|---|---|---|
| Spoon | 3.7 | 2.4 |
| Fork | 3.7 | 2 |
| Knife | 3.7 | 2 |
| | Heavy Duty PP (g) | Inventive PP (g) |
| Spoon | 3.3 | 2.1 |
| Fork | 3.3 | 1.8 |
| Knife | 3.3 | 1.7 |
| | Heavy Duty CA (g) | Inventive CA (g) |
| Spoon | 4.7 | 2.9 |
| Fork | 4.7 | 2.5 |
| Knife | 4.7 | 2.5 |
| | Heavy Duty PLA (g) | Inventive PLA (g) |
| Spoon | 4.5 | 2.9 |
| Fork | 4.5 | 2.4 |
| Knife | 4.5 | 2.4 |

As shown in Table 4, forming spoons as described herein enables a weight reduction of around 36%; forming forks as described herein enables a weight reduction of around 46%; and forming knives as described herein enables a weight reduction of around 47%.

### Example 4: Comparison of Cycle Times for Different Article Thickness

Forks were formed as described herein from polyhydroxyalkanoate (PHA) having a uniform thickness and standard heavy-duty cross-section (such as the cross-section characteristic of Great Value® Premium Disposable Plastic Forks). The forks were molded on a 100 ton molding machine equipped with a hot-to-cold runner. Two thickness modalities were tested, one fork that had a uniform thickness of 30 mils, and another resembling conventional disposable forks with a thickness ranging from 30 mil to 100 mil: 100 mil at the neck and a skirt of 60 mil. The cycle time was optimized for flat parts with the same melt conditions (300° F.). The clamping, injection, and ejection portions of the molding cycle were identical, but the cooling step was adjusted from an initial 18 second set point and reduced by 1 second until the fork was observed to warp. It was unexpectedly discovered that the cooling step can be reduced from 22 seconds for the thick-and-thin fork by 2 seconds, or about 10% of the overall cycle time, to only 20 seconds for the uniform thickness fork, without impacting the quality of the mold.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

1. An article of disposable cutlery comprising:
a handle portion;
a utility portion; and
a skirt along a perimeter of the handle portion and at least part of the utility portion,
wherein the skirt has an angle relative to the handle portion and at least part of the utility portion of greater than 90 degrees to about 135 degrees, and
wherein the handle portion, the skirt, and at least part of the utility portion have a common, uniform thickness.

2. The article of disposable cutlery of claim 1, wherein the handle portion has a continuous, uninterrupted surface.

3. The article of disposable cutlery of claim 1, wherein the handle portion has exactly one line of symmetry about a longitudinal axis.

4. The article of disposable cutlery of claim 1, wherein the handle portion has zero lines of symmetry about a longitudinal axis.

5. The article of disposable cutlery of claim 1, wherein the handle portion has rotational symmetry of order two.

6. The article of disposable cutlery of claim 1, wherein the article of cutlery has a shape that is configured to interlock with a second article of cutlery having the same shape.

7. The article of disposable cutlery of claim 6, wherein the article of cutlery has a first height, the second article of cutlery has a second height, the first height and second height being equal, and
wherein, when the article of cutlery and the second article of cutlery are interlocked, a combined height is less than the sum of the first height and the second height.

8. The article of disposable cutlery of claim 1, wherein the common, uniform thickness is about 30 mil.

9. The article of disposable cutlery of claim 1, wherein the article of disposable cutlery is a spoon.

10. The article of disposable cutlery of claim 1, wherein the article of disposable cutlery is a fork.

11. The article of disposable cutlery of claim 10, wherein the fork has a plurality of tines, each tine having a tine skirt having a thickness less than the thickness of the utility portion.

12. The article of disposable cutlery of claim 1, wherein the article of disposable cutlery is a knife.

13. The article of disposable cutlery of claim 1, wherein the article of disposable cutlery is formed from one or more of polystyrene, polypropylene, polyhydroxyalkanoate, cellulose acetate, and polylactic acid.

14. The article of disposable cutlery of claim 1, wherein the article of disposable cutlery is compostable.

15. An article of disposable cutlery comprising:
a handle portion;
a utility portion; and
a skirt along a perimeter of the handle portion and at least part of the utility portion,
wherein the handle portion and at least a portion of the utility portion have a common, uniform thickness, and
wherein the skirt has a skirt thickness, the skirt thickness being 70% of the common, uniform thickness.

16. A method of forming the article of disposable cutlery of claim 1, wherein the method comprises molding the article of disposable cutlery,
wherein a cycle time associated with molding the article of disposable cutlery is between 20% and 35% faster than molding a conventional piece of disposable cutlery.
